(19) United States
(12) Patent Application Publication
(10) Pub. No.: US 2022/0327564 A1
(43) Pub. Date: Oct. 13, 2022

(54) SYSTEM AND METHOD FOR GENERATION OF A USER FEEDBACK DATA

(71) Applicant: FLIPKART INTERNET PRIVATE LIMITED, Bengaluru (IN)

(72) Inventors: Mayank Kant, Bengaluru (IN); Aditya Kumar, Bengaluru (IN); Sneh Gupta, Bengaluru (IN); Sumit Gupta, Bengaluru (IN); Vandana Kanwar, Bengaluru (IN); Ravi Vijaya Raghavan, Bengaluru (IN)

(73) Assignee: FLIPKART INTERNET PRIVATE LIMITED, Bengaluru (IN)

(21) Appl. No.: 17/491,092

(22) Filed: Sep. 30, 2021

(30) Foreign Application Priority Data
Mar. 10, 2021 (IN) 202141010012

(51) Int. Cl. G06Q 30/02; G06Q 50/00

(52) U.S. Cl. CPC G06Q 30/0204; G06Q 50/01

(57) ABSTRACT

A system and method for generation of a user feedback data is provided. The method encompasses extracting in real time, from social media platform(s), a set of social media posts, wherein each social media post comprises mention(s) related to e-commerce platform(s). The method thereafter encompasses categorizing, each social media post into one of a promotional post and non-promotional post. The method further comprises identifying, a sentiment associated with each social media post. Further, the method encompasses assigning, a customer experience node and/or a business unit with the social media post(s). The method thereafter leads to removing, irrelevant posts from the set of social media posts. The method then generates the user feedback data based on the removal of the at least one irrelevant post and the assigned customer experience node, the assigned business unit and/or the sentiment of each social media post.

### TECHNICAL FIELD

The field generally relates to decision science and more particularly, to a system and method for generation of user feedback data.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With the advancement in digital technologies, e-commerce platforms are also enhanced to a great extent. Users can easily buy products of their interest digitally via these e-commerce platforms and such products are delivered to the users at their doorsteps. Also, not only the facility for buying products is provided by e-commerce platforms but other facilities such as easy exchange/return of the products, real time customer care support and the like are also provided to the users.

Also, the users/customers and the e-commerce platforms/companies are generally linked to various social media platforms. Such social media platforms have become ubiquitous and important platforms for social networking, content sharing and marketing. The customers/users usually post their concerns/experience related to the e-commerce platforms on the social media platforms. The customers can easily reach out to an e-commerce platform/company to resolve their queries related to any product or any service offered by the e-commerce platforms via one or more social media platforms. Therefore, to understand the customers'/users' requirements and other important parameters (such as a market share, a net promoter score (NPS) and the like), there is a requirement to generate a user feedback data based on the information/reviews posted by the customers/users on the social media platforms.

Due to extensive use of short forms and other personal elements of writing in the social media posts, it remains one of the most complex and challenging data to analyze and extract relevant information. More particularly, in social media posts, roughly only 1 mention out of every 10 is from a customer or product user, which is important to understand the sentiment of a product or line of business or an organization.

Currently, known solutions have failed to effectively and efficiently analyze and retrieve the e-commerce related information/reviews posted on the social media platforms. More specifically, none of the currently known solutions are able generate the user feedback data based on the analysis of e-commerce related data available on social media platforms to estimate important metrics like customer experience, sentiment of a product, line of business or an organization, market share and the like.

Therefore, there is a need in the art to provide a novel solution to effectively and efficiently generate user feedback data based on analysis of e-commerce related data available on the social media platforms to estimate important metrics like customer experience, sentiment of a product, line of business or an organization, market share and the like.

### SUMMARY OF THE DISCLOSURE

This section is provided to introduce certain objects and aspects of the disclosure in a simplified form that are further described below in the detailed description.

This summary is not intended to identify the key features or the scope of the claimed subject matter.

In order to overcome at least some of the drawbacks mentioned in the previous section and those otherwise known to persons skilled in the art, an object of the present invention is to provide a system and method to provide an intelligent solution to efficiently and effectively retrieve useful information from the social media platforms. Another object of the present invention is to provide a system and method to estimate an e-commerce company's/business unit's most important metrics like customer experience (Net Promoter Score (NPS), Pricing, etc.) and Market Share with high accuracy. Also, another object of the present invention is to provide a system and method to filter promotional content, decipher sentiment and extract Business Units (BUs) & Customer Experience Nodes (L1/L2) from various multi-lingual social media posts related to an e-commerce platform/service (which includes emoji's, different languages, short forms and other personal elements of writing).

In order to achieve the aforementioned objectives, the present invention provides a method and system for generation of a user feedback data. The method comprises extracting in real time, by an extraction unit, from one or more social media platforms, a set of social media posts, wherein each social media post comprises at least one mention related to one or more e-commerce platforms.

The method thereafter encompasses categorizing, by a categorization unit, each social media post of the set of social media posts into one of a promotional post and non-promotional post based on a first pre-trained dataset. The method thereafter comprises identifying, by a processing unit, a sentiment associated with each social media post based on a second pre-trained dataset. Further, the method encompasses assigning, by the processing unit, at least one of a customer experience node and a business unit with one or more text in each social media post based on a third pre-trained dataset. The method thereafter leads to removing, by the processing unit, at least one irrelevant post from the set of social media posts based at least on at least one of an absence of the customer experience node and a presence of the promotional post. The method further comprises generating, by the processing unit, the user feedback data from the set of social media posts, based on the removal of the at least one irrelevant post and at least one of the assigned customer experience node of each social media post, the assigned business unit of each social media post, and the sentiment of each social media post.

Another aspect of the present invention relates to a system for generation of a user feedback data. The system comprises an extraction unit, configured to extract in real time from one or more social media platforms, a set of social media posts, wherein each social media post comprises at least one mention related to one or more e-commerce platforms. Also, the system further comprises a categorization unit, configured to categorize each social media post of the set of social media posts into one of a promotional post and non-promotional post based on a first pre-trained dataset. Further the system also comprises a processing unit, configured to identify a sentiment associated with each social media post based on a second pre-trained dataset. The processing unit is thereafter configured to assign, at least one of a customer experience node and a business unit with one or more text in each social media post based on a third pre-trained dataset. Further the processing unit is configured to remove, at least one irrelevant post from the set of social media posts based at least on at least one of an absence of the customer experience node and a presence of the promotional post. The processing unit is then configured to generate, the user feedback data from the set of social media posts, based on the removal of the at least one irrelevant post and at least one of the assigned customer experience node of each social media post, the assigned business unit of each social media post, and the sentiment of each social media post.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for generation of a user feedback data, in accordance with exemplary embodiments of the present invention.

FIG. 2 illustrates an exemplary method flow diagram [200], depicting a method for generation of a user feedback data, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As disclosed in the background section, the existing technologies have many limitations and in order to overcome at least some of the limitations of the prior known solutions, the present disclosure provides a solution for generation of a user feedback data. More particularly, the present disclosure provides a solution to generate a user feedback data related to e-commerce platforms based on a real time extraction of one or more useful information from various social media platforms. Also, the present disclosures provides a solution to estimate an e-commerce company's/business unit's most important metrics like customer experience (net promoter score (NPS), pricing, etc.) and market share with more than 95% accuracy, wherein the customer experience and the market share is estimated based on the user feedback data.

To generate the user feedback data, the present disclosure encompasses extracting in real time from social media platforms, a data comprising at least a plurality of mentions related to various e-commerce platforms. Further, one or more contents of such data are categorized into one of a promotional content and a non-promotional content to filter out the promotional contents. Further a sentiment associated with the one or more contents is identified, wherein such one or more contents may comprise multi-lingual social language which includes emojis, hinglish (combination of Hindi and English language), short forms and other personal elements of writing. Thereafter, one or more business units and one or more customer experience nodes are identified in the one or more contents. Also, a customer experience node may be one of a Layer 1 (i.e. L1) node and a Layer 2 (L2) node, wherein the L1 node is of a higher priority than the L2 node. Further, the user feedback data is generated based on the filtration of promotional contents from the one or more contents, identification of the sentiment associated with the one or more contents and the business units and the one or more customer experience nodes present in the one or more contents. Also, once the user feedback data is generated, the present invention encompasses generating at least one of a social share metric and a social sentiment score of the one or more e-commerce platforms based on the user feedback data. In an implementation, the present invention also encompasses determining one of a net promoter score and a gross merchandise value related to an e-commerce company based on the generated user feedback data. More particularly, the net promoter score is determined based on the generated social sentiment score and the gross merchandise value is determined based on the generated social sentiment score and the social share metric.

As used herein, a “processing unit” or “processor” or “operating processor” includes one or more processors, wherein processor refers to any logic circuitry for processing instructions, such as those corresponding to method steps described herein. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a user, a processing unit, a storage unit, a display unit, a transceiver unit, a server unit and any other such unit(s) which are obvious to the person skilled in the art and are capable of implementing the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

The present disclosure is further explained in detail below with reference now to the drawings.

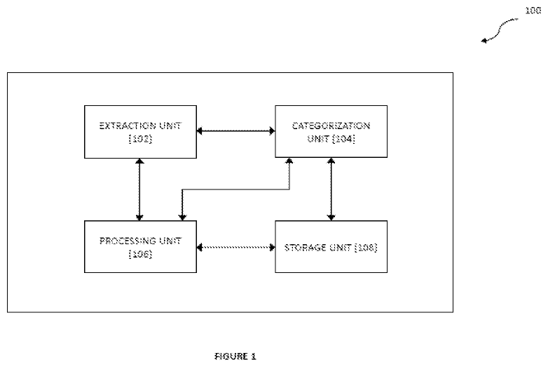

Referring to FIG. 1, an exemplary block diagram of a system [100] for generation of a user feedback data, in accordance with exemplary embodiments of the present invention is shown. As shown in FIG. 1, the system encompasses at least one extraction unit [102], at least one categorization unit [104], at least one processing unit [106] and at least one storage unit [108]. In an implementation, the system [100] may reside in a server device. All of the components/units of the system [100] are assumed to be connected to each other unless otherwise indicated below. Also, in FIG. 1 only a few units are shown, however, the system [100] may comprise multiple such units or the system [100] may comprise any such numbers of said units, obvious to a person skilled in the art or as required to implement the features of the present disclosure.

The system [100] is configured for generation of a user feedback data with the help of the interconnection between the components/units of the system [100]. The extraction unit [102] is configured to extract in real time from one or more social media platforms, a set of social media posts, wherein each social media post comprises at least one mention related to one or more e-commerce platforms. As used herein, “social media posts” refer to any content published or posted by a user on any social networking website, platform or application. The social media posts may be in the form of text, audio, image, video, or any other form of content as obvious to a person skilled in the art. The social media posts referred herein include mention/s of e-commerce platform/s. For instance, a text posted by a user on a social media platform may refer to the e-commerce platform of Flipkart.

Further, the invention encompasses that the set of social media posts comprises a plurality of social media posts in multilingual text. Also, in an example one or more social media posts of the set of social media posts may include emoji's, different languages, short forms and other personal elements of writing.

In an implementation, the set of social media posts is extracted and analyzed by the extraction unit [102] based on a pre-trained data set. The pre-trained data set comprises a plurality of data trained based on a large general-domain corpus (such as customer reviews and general language (such as English)) to identify a sentence structure of a source language. Also, based on the pre-trained data set a next word in a sequence can be predicted. Further, in an implementation, the pre-trained data set may further be updated based on a target dataset comprising various social media reviews relating to e-commerce platforms, to identify task-specific features of a language such as usage of slang and the like. Furthermore, in an implementation, one or more social media posts from the set of social media posts comprising a non-English language (such as Hinglish, Hindi, Tamil, Bangla, etc.) are converted into English language based on the pre-trained data set. Thereafter, such converted English language of said one or more social media posts is then further processed based on the pre-trained data set to remove at least one of one or more URLs, email-ids, phone numbers, emojis, etc. present in the social media post/s.

The categorization unit [104] is configured to categorize each social media post of the set of social media posts into one of a promotional post and non-promotional post based on a first pre-trained dataset or model. As used herein, the “promotional post” or “promotional data” refers to any content posted or published on the one or more social media platforms to increase reach of one or more products and/or one or more services of an e-commerce company, i.e. increase the number of users who view and/or buy the one or more products and/or one or more services. Promotional posts are typically posted or published by the e-commerce companies directly to promote their products/services or by social media influencers who publish such posts on behalf of or in tie up with the e-commerce companies to promote products/services. As used herein, a “non-promotional post” or “non-promotional content” refers to any other content posted or published by the user other than the promotional content.

The first pre-trained dataset comprises a plurality of data trained based at least on a promotional data associated with the one or more e-commerce platforms and a non-promotional data associated with the one or more e-commerce platforms. Furthermore, the categorization of each social media post into one of the promotional post and the non-promotional post is achieved to filter the promotional posts from the set of social media posts.

In an example, the below exemplary social media post is categorized as a promotional post:

ABC e-commerce Company posted on a social media platform A—“DEAL ALERT!! HEAVY DISCOUNT ON MOBILE PHONES ON ABC E-COMMERCE PLATFORM”.

Also, the below exemplary social media post is categorized as a non-promotional post:

User ABC posted on a social media platform A—“How to cancel our order in Flipkart????? . . . .”

The processing unit [106] is configured to identify a sentiment associated with each social media post based on a second pre-trained dataset. As used herein, “sentiment” refers to any emotion of the user associated with the product/service as is reflected in the social media post published by the user. The sentiment is one of a positive sentiment, a negative sentiment and a neutral sentiment.

Also, the second pre-trained dataset comprises a plurality of data trained based at least on a sentimental data associated with the one or more e-commerce platforms. More particularly, based on the second pre-trained dataset, each social media post of varying length such as small, medium, or paragraph-type is analyzed to identify an associated positive sentiment, negative sentiment or a neutral sentiment.

For example, the sentiment associated with the below exemplary social media post is identified as NEGATIVE:

“Flipkart is hiring very unprofessional delivery fellows who are ill-mannered and don't know how to talk with women.”

Also, in another example, the sentiment associated with the below exemplary social media post is identified as NEUTRAL:

“How to cancel our order in Flipkart????? . . . .”

In yet another example, the sentiment associated with the below exemplary social media post is identified as POSITIVE:

“@Flipkart Eagerly Waiting [symbol] ”

Furthermore, the processing unit [106] is also configured to identify a sentiment associated with the one or more social media posts from the set of social media posts comprising non-English language. For example, sentiment associated with the below exemplary social media content posted in Hinglish language (i.e. in combination of Hindi and English) is identified as NEGATIVE:

“@rajnathsingh Wo sab thik hain par @Flipkart garibo ko loot rahi hain, mere sath dhoka Kiya @Flipkart ne, bahut pareshan ho Gaya hoon, muje tuta mobile de Diya Flipkart ne aur ab ignore Kar rahe hain”

The processing unit [106] is further configured to assign, at least one of a customer experience node and a business unit with one or more text in each social media post based on a third pre-trained dataset. The third pre-trained dataset comprises a plurality of data trained based at least on a customer experience node-based data associated with the one or more e-commerce platforms and a business unit based data associated with the one or more e-commerce platforms. Furthermore, the customer experience node is assigned at least to analyze a customer experience in each customer journey node like delivery, pricing, customer care and the like.

Further, the customer experience node comprises one of a layer 1 (L1) and a layer 2 (L2) customer experience node. The L1 node is a customer journey node related to various features associated with a process of ordering a product to delivering said product, for example Cancellation, Customer_Care, Delivery, Payment, Pricing, Product_Quality, Promotional, Return, Selection and the like are L1 customer experience nodes. Also, the L2 node is a sub node of a L1 node such as one of a ‘Company Initiated’, ‘Cust Initiated Product Quality’, ‘Cust Initiated Speed’, ‘Fraud Orders’, ‘Policy’, ‘Refund’ and the like are the L2 node for the Cancellation L1 node.

Similarly:

One of a ‘Speed’, ‘Delivery Quality’, ‘Changing delivery time’, ‘Delivery Agent Behaviour’, ‘Communication’ and the like are L2 node for the Delivery L1 node.

One of an ‘Issue Resolution’, ‘Ease to reach agent’, ‘Response Time’, ‘Communication’ and the like are L2 node for the Customer Care L1 node.

One of a ‘Debit/Credit Card, Net banking’, ‘EMI/BPNL Mode’, ‘Bank/Account Issue’, ‘Wallets’, ‘Cashback’, ‘COD’ and the like are L2 node for the Payment L1 node.

The business unit is assigned with the one or more text in each of the social media post to define a category/type of a business product. For example: a text “large” is assigned as a business unit, a text “laptop” is assigned as a business unit, a text “Handset” is assigned a business unit, a text “Electronics” is assigned as a business unit, a text “Lifestyle” is assigned a business unit and the like. Also in one other example if a social media post has a word ABC mobile, then ABC is tagged/assigned as “Handset” business unit, but when the social media post has a word ABC TV, the ABC is tagged/assigned to “Large” business unit and not to the “Handset” business unit. More particularly, words/text associated with a type and/or category of a product or service is assigned with the business unit.

Also, in an implementation one or more NEAR keywords/text, OR keywords/text and NOT keywords/text are identified in each social media post to assign at least one of the customer experience node and the business unit with one or more text/keywords in said each social media post.

Also in an implementation, the processing unit [106] is further configured to identify, a priority associated with at least one of the customer experience node and the business unit. For each of the customer experience node and the business unit, the associated priority is a pre-defined priority order.

In an implementation, keywords that are exclusively used for one business unit (BU) are given higher priority than the one which belongs to multiple BUs. For example, in social media post/s, a keyword used in context of both Mobile and Laptop (Electronics), is associated with a less priority, but a keyword exclusively used for Mobile or Laptop is associated with a higher priority. For instance, if ABC manufactures both laptops and mobile, the processing unit [106], for a post “I liked this ABC laptop”, is configured to tag/assign the text laptop with a BU—Electronics, even though said post has one keyword of a mobile BU (ABC) and one keyword of a Large BU (Laptop), based on the pre-defined priority order.

Also, in an implementation a L1 node is assigned with a higher priority than a L2 node. For instance, if a customer posts on a digital platform “Amazing service by Flipkart, Product got delivered on time and agent behaviour was also great” then the above post would get tagged to Delivery L1 and L2 would be Speed and Agent Behaviour and no other L1 and L2 will be tagged. Even though “Agent behaviour” L2 is also a part of various other L1's like Customer Care, Installation, etc. Also, in another implementation each of the L1 nodes from various L1 nodes are assigned with a pre-defined order of priority and in case of conflict lower priority L1 will only get tagged if any L2 issue is identified. For instance, let's say if someone posts “Flipkart customer care agents always put my call on hold. Flipkart delivers fake products and loot customers hard earned money @cheaterFlipkart.” In an implementation the above post will get tagged to Customer Product Quality L1 and Customer Care L1 even though Customer Care has lower priority than Product Quality because L2 for Customer Care is identified which is “Communication with Agent” and the post will not get tagged to “delivery” L1 even though keyword delivers was present, because none of the L2 issue is present.

The processing unit [106] is also configured to resolve one or more conflicts associated with one of the L1 and the L2 customer experience nodes based on the identified priority associated with at least one of the customer experience nodes and the business unit. For example, if two L1 nodes i.e. Delivery and Customer_Care is assigned with a social media post and the Delivery node is associated with a higher priority than the Customer_Care node, in such instance the processing unit [106] is firstly configured to resolve, one or more conflicts associated with the Delivery node and thereafter the processing unit [106] is configured to resolve, one or more conflicts associated with the Customer_Care node, i.e. basis the priority order.

Further, the processing unit [106] is also configured to remove, at least one irrelevant post from the set of social media posts based at least on at least one of an absence of the customer experience node and a presence of the promotional post. More particularly, the processing unit [106] is configured to remove one or more promotional social media posts and one or more social media posts having no customer experience node from the set of social media posts. Also, in an implementation the processing unit [106] is also configured to further remove one or more news related content/posts, viral contents/posts, direct message/text from customer care support, posts from customer care support and the like from the set of social media posts.

Also, the processing unit [106] is further configured to generate, the user feedback data from the set of social media posts, based on the removal of the at least one irrelevant post and at least one of the assigned customer experience node of each social media post, the assigned business unit of each social media post, and the sentiment of each social media post. Also, the user feedback data comprises at least a set of mentions associated with the one or more e-commerce platforms.

Furthermore, in an implementation the processing unit [106] is further configured to generate, the user feedback data from the set of social media posts, based on a further removal of the one or more news related content/posts, the viral contents/posts, the direct message/text from customer care support, the posts from customer care support and the like, from the set of social media posts.

Also, the processing unit [106] is further configured to generate at least one of a social share metric and a social sentiment score of the one or more e-commerce platforms based on the user feedback data. The social share metric for a first e-commerce platform is generated based on a ratio of said first e-commerce platform's mentions present in the user feedback data to overall mentions present in the user feedback data. Also, the social sentiment score for the first e-commerce platform is generated based on a difference between a user feedback data associated with the first e-commerce platform and a user feedback data associated with a second e-commerce platform.

Further, the processing unit [106] is configured to generate at least one of the social share metric and the social sentiment score based on aggregating the user feedback data on at least one of a customer experience node level, geographical level, and business unit level. Also, in an implementation while aggregating the user feedback data, tier and over-negative adjustments are done using a RNPS (Relational NPS) data to avoid social bias (such as Metro users are more active on social media platforms than Non-metro users).

The customer experience node level further comprises customer journey/experience nodes L1 and L2. The geographical level comprises one or more Metro and Non Metro cities, one or more zones and one or more states. The business unit level comprises one or more business units such as Electronics, Lifestyle, Handset and the like.

Also, the processing unit [106] is further configured to determine one of a net promoter score (NPS) and a gross merchandise value (GMV/Market share) based on the user feedback data. More particularly, the net promoter score is determined based on the generated social sentiment score and the gross merchandise value is determined based on the generated social sentiment score and the social share metric.

Furthermore, to determine the NPS, the processing unit [106] is further configured to identify one or more correlated features from a set of features associated with the social sentiment score. Once the one or more correlated features are identified, the processing unit [106] is further configured to remove one or more highly correlated features, wherein the one or more highly correlated features are correlated with each other above a pre-defied threshold level (in an example the pre-defined threshold level may be 85%). Further in an implementation, most important feature/s are identified from the remaining features associated with the social sentiment score. Thereafter, the processing unit [106] is configured to determine the NPS based on said identified most important feature/s.

Also, to determine the gross merchandise value, the processing unit [106] is further configured to identify a set of features associated with the social sentiment score and the social share metric. Thereafter, the processing unit is configured to identify a final set of features with their correct coefficients on the basis of an out-of-time mean cross-validation score. Further, in order to determine the gross merchandise value, the processing unit [106] is configured to replace one or more features having a opposite sign with a feature with correct sign or the processing unit [106] is further configured to drop the one or more features having the opposite sign in an event dropping said one or more features having the opposite sign gives a low out-of-time mean cross-validation score.

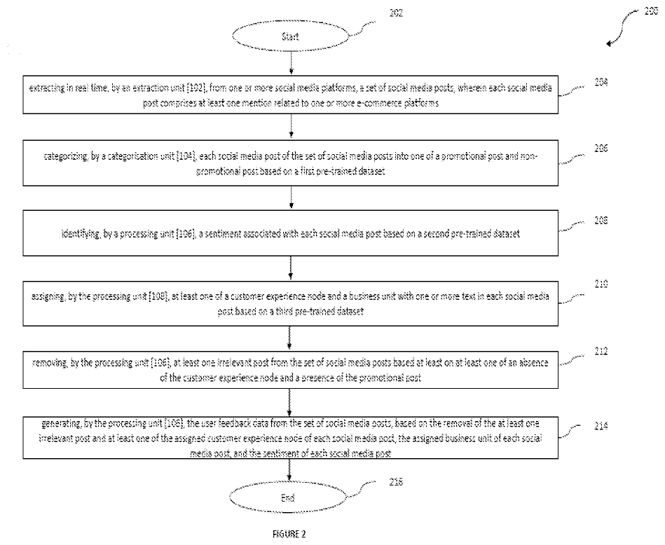

Referring to FIG. 2, an exemplary method flow diagram [200], depicting a method for generation of a user feedback data, in accordance with exemplary embodiments of the present invention is shown. In an implementation the method can be implemented at a server. As shown in FIG. 2, the method begins at step [202]. In an example, the method may begin based on an input from an administrative user. In another example, the method is a continuous process that keeps running and extracting data.

At step [204], the method comprises extracting in real time, by an extraction unit [102], from one or more social media platforms, a set of social media posts, wherein each social media post comprises at least one mention related to one or more e-commerce platforms. Furthermore, the set of social media posts may comprise a plurality of social media posts in multilingual text. For instance, one or more social media posts of the set of social media posts may include emoji's, different languages, short forms and other personal elements of writing.

Also in an implementation, the method encompasses analyzing via a processing unit [106], the set of social media posts based on a pre-trained data set. The pre-trained data set comprise a plurality of data trained based on a large general-domain corpus (such as customer reviews and general language (such as English)) to identify a sentence structure of a source language. Also, based on the pre-trained data set a next word in a sequence can be predicted. Further, in an implementation the pre-trained data set may further be updated based on a target dataset comprising various social media reviews relating to e-commerce platforms, to identify task-specific features of a language such as usage of slang and the like. Furthermore, in an implementation, one or more social media posts from the set of social media posts comprising a non-English language (such as Hinglish, Hindi, Tamil, Bangla, etc.) are converted into English language based on the pre-trained data set, by the processing unit [106]. Thereafter, such converted English language of said one or more social media posts is then further processed by the processing unit [106], based on the pre-trained data set to remove at least one of one or more URLs, email-ids, phone numbers, emojis, etc. present in the social media post/s.

In an implementation, the extraction step is a continuous process, i.e. the method encompasses continuously extracting social media posts from one or more social media platforms and subsequently processing the same as defined in the below steps.

Next, at step [206], the method comprises categorizing, by a categorization unit [104], each social media post of the set of social media posts into one of a promotional post and non-promotional post based on a first pre-trained dataset. The first pre-trained dataset comprises a plurality of data trained based at least on a promotional data associated with the one or more e-commerce platforms and a non-promotional data associated with the one or more e-commerce platforms. Also, the promotional data further comprises one or more contents posted on the one or more social media platforms to increase reach of one or more products and/or one or more services of an e-commerce company. Furthermore, the method encompasses categorizing said each social media post into one of the promotional post and the non-promotional post to filter the promotional posts from the set of social media posts.

Thereafter, at step [208], the method comprises identifying, by a processing unit [106], a sentiment associated with each social media post based on a second pre-trained dataset. The sentiment is one of a positive sentiment, a negative sentiment and a neutral sentiment. Also, the second pre-trained dataset comprises a plurality of data trained based at least on a sentimental data associated with the one or more e-commerce platforms. More particularly, the method encompasses analyzing by the processing unit [106], each social media post of varying length such as small, medium, or a paragraph-type post based on the second pre-trained dataset, to identify an associated positive sentiment, negative sentiment or a neutral sentiment.

For example, the sentiment associated with the below exemplary social media post is identified as NEGATIVE:

“@surendarbaid @flipkartsupport @Flipkart @jeeves I got similar mail from Jeeves asking 4 more business days to generate tracking id on 4 July and its 11 so I can say it's just a candy to divert ur anger nothing more! @flipkartsupport will stop calling you after those 4 days timeline just as they avoid calling me ever since.”

Also, in another example, the sentiment associated with the below exemplary social media post is identified as NEUTRAL:

“Thank you for sharing the requested details with us. Be assured, we'll look into it and one of our specialists will get in touch with you via call/email to address the concern at the earliest. We appreciate your patience. In the future, please do not share your details like phone number, email address, or order ID here. To ensure your Flipkart account details are safe, please start a private chat with us by clicking on the following link.—Sachin m.me/Flipkart.”

In yet another example, the sentiment associated with the below exemplary social media post is identified as POSITIVE:

“Amazing as this is, I think e-commerce needs to grow faster. India is adding 3 e-commerce markets equivalent every year to the overall retail market. ABC and XYZ are still largely focused on hard lines. Consumables and soft lines are hard problems to solve.”

Also, in an implementation, the method also encompasses identifying a sentiment associated with the one or more social media posts from the set of social media posts comprising the non-English language. For example, sentiment associated with the below exemplary social media content posted in Hindi language is identified as NEGATIVE:

“@ABC_Bank [symbol] Flipkart [symbol] 30 [symbol] [symbol] [symbol] flipkart [symbol] [symbol] flipkart [symbol] [symbol] [symbol] [symbol] [symbol] flipkart [symbol] OD110000000000000011 [symbol] , Refund Id 123456789

[symbol]

Also in one another example, sentiment associated with the below exemplary social media content posted in Marathi language is identified as NEGATIVE:

“ [symbol] [symbol] [symbol] [symbol] [symbol] .”

Next, at step [210], the method comprises assigning, by the processing unit [106], at least one of a customer experience node and a business unit with one or more text in each social media post based on a third pre-trained dataset. The third pre-trained dataset comprises a plurality of data trained based at least on a customer experience node-based data associated with the one or more e-commerce platforms and a business unit based data associated with the one or more e-commerce platforms.

Further, the customer experience node comprises one of a layer 1 (L1) and a layer 2 (L2) customer experience node. The L1 node is a customer journey node related to various features associated with a process of ordering a product to delivering said product, for example Cancellation, Customer_Care, Delivery, Payment, Pricing, Product_Quality, Promotional, Return, Selection and the like are L1 customer experience nodes. Furthermore, the customer experience node is assigned at least to analyze a customer experience in each customer journey/experience node like delivery, pricing, customer care and the like. Also, the L2 node is a sub node of a L1 node, such as one of an ‘Offers Quality’, ‘Price Genuiness’, Buy-Back/Prexo′, ‘Shipping Charges’ and the like are the L2 node for the Pricing L1 node.

Similarly:

One of a ‘Damaged/Defective Product’, ‘Genuinity’, ‘Product_description’ and the like are L2 node for the Product_Quality L1 node.

One of a ‘Refund’, ‘Communication regarding return repalcement’, ‘Policy Issues’, ‘Delivery/Pick up Experience’ and the like are L2 node for the Return L1 node.

One of a [OOS, Unavailable]′, ‘Variety’, ‘Non Servicable’ and the like are L2 node for the Selection L1 node.

Furthermore, the business unit is assigned with the one or more text in each of the social media post to define a category/type of a business product. For example: a text “Watch” is assigned as a business unit, a text “smartphone” is assigned as a business unit, a text “Smartwatch” is assigned a business unit, a text “Electronics” is assigned as a business unit, a text “Lifestyle” is assigned a business unit and the like. Also in one other example if a social media post has a text XYZ laptop, then XYZ is tagged/assigned as “Electronics” business unit, but when the social media post has a text XYZ TV, the XYZ is tagged/assigned to “Large” business unit and not to the “Electronics” business unit. More particularly, words/text associated with a type and/or category of a product or service is assigned with the business unit.

Also, in an implementation the method encompasses identifying via the processing unit [106], one or more NEAR keywords/text, OR keywords and NOT keywords in each social media post to assign at least one of the customer experience node and the business unit with one or more text/keywords in said each social media post.

Also in an implementation, the method further comprises identifying by the processing unit [106], a priority associated with at least one of the customer experience node and the business unit. Also, for each of the customer experience node and the business unit, the associated priority is a pre-defined priority order.

Further, in an implementation, keywords that are exclusively used for one business unit (BU) are given higher priority than the one which belongs to multiple BUs. For example, in social media post/s, a keyword used in context of both smartwatch and smartphone, is associated with a less priority, but a keyword exclusively used for the smartphone or the smartwatch is associated with a higher priority. For instance, if XYZ manufactures both smartwatch and smartphone, then the method for a post “I liked this XYZ smartphone”, encompasses tagging/assigning via the processing unit [106], the text smartphone with a BU—Handset, even though said post has one keyword of a smartwatch BU (i.e. XYZ) and one keyword of a Handset BU (i.e. smartphone), based on the pre-defined priority order.

Also, in an implementation a L1 node is assigned with a higher priority than a L2 node. Also in another implementation each of the L1 node from various L1 nodes are assigned with a pre-defined order of priority.

Also, the method further comprises resolving by the processing unit [106], one or more conflicts associated with one of the L1 and the L2 customer experience node based on the identified priority associated with at least one of the customer experience node and the business unit. For example, if two L1 nodes i.e. Payment and Pricing is assigned/tagged with a social media post and the Payment node is associated with a higher priority than the pricing node, in such instance the method firstly encompasses resolving by the processing unit [106], one or more conflicts associated with the Payment node and thereafter the method encompasses resolving by the processing unit [106], one or more conflicts associated with the Pricing node, i.e. basis the priority order.

Further, at step [212], the method comprises removing, by the processing unit [106], at least one irrelevant post from the set of social media posts based at least on at least one of an absence of the customer experience node and a presence of the promotional post. More particularly, the method encompasses removing by the processing unit [106], one or more promotional social media posts and one or more social media posts having no customer experience node, from the set of social media posts. Also, in an implementation the method also encompasses removing by the processing unit [106], one or more news related content/posts, viral contents/posts, direct message/text from customer care support, posts from customer care support and the like from the set of social media posts.

Next, at step [214], the method comprises generating, by the processing unit [106], the user feedback data from the set of social media posts, based on the removal of the at least one irrelevant post and at least one of the assigned customer experience node of each social media post, the assigned business unit of each social media post, and the sentiment of each social media post. Also, the user feedback data comprises at least a set of mentions associated with the one or more e-commerce platforms.

Furthermore, in an implementation the method also comprises generating by the processing unit [106], the user feedback data from the set of social media posts, based on a further removal of the one or more news related content/posts, the viral contents/posts, the direct message/text from customer care support, the posts from customer care support and the like, from the set of social media posts.

Further, the method also comprises generating at least one of a social share metric and a social sentiment score of the one or more e-commerce platforms based on the user feedback data. The social share metric for a first e-commerce platform is generated based on a ratio of said first e-commerce platform's mentions present in the user feedback data to overall mentions present in the user feedback data. Also, the social sentiment score for the first e-commerce platform is generated based on a difference between a user feedback data associated with the first e-commerce platform and a user feedback data associated with a second e-commerce platform.

Thereafter, the method also comprises generating at least one of the social share metric and the social sentiment score based on aggregating the user feedback data on at least one of a customer experience node level, geographical level, and business unit level. Also, in an implementation while aggregating the user feedback data, tier and over-negative adjustments are done using a RNPS (Relational NPS) data to avoid social bias (such as Metro users are more active on social media platforms than Non-metro users). Also, the customer experience node level further comprises customer journey/experience nodes L1 and L2. The geographical level comprises one or more Metro and Non Metro cities, one or more zones and one or more states. The business unit level comprises one or more business units such as Electronics, Lifestyle, Handset and the like.

Also, the method further comprises determining one of a net promoter score (NPS) and a gross merchandise value (GMV/Market share) based on the user feedback data. More particularly, the net promoter score is determined based on the generated social sentiment score and the gross merchandise value is determined based on the generated social sentiment score and the social share metric.

Furthermore, to determine the NPS, the method encompasses identifying by the processing unit [106], one or more correlated features from a set of features associated with the social sentiment score. Once the one or more correlated features are identified, the processing unit [106] is further configured to remove one or more highly correlated features, wherein the one or more highly correlated features are correlated with each other above a pre-defied threshold level. Further in an implementation, most important feature/s are identified from the remaining features associated with the social sentiment score. Thereafter, the method encompasses determining by the processing unit [106], the NPS based on said identified most important feature/s.

Also, to determine the gross merchandise value method encompasses identifying by the processing unit [106], a set of features associated with the social sentiment score and the social share metric. Thereafter, method encompasses identifying by the processing unit [106], a final set of features with their correct coefficients on the basis of an out-of-time mean cross-validation score. Further, in order to determine the gross merchandise value, method encompasses replacing by the processing unit [106], one or more features having a opposite sign with a feature with correct sign or the method encompasses dropping by the processing unit [106] the one or more features having the opposite sign in an event dropping said one or more features having the opposite sign gives a low out-of-time mean cross-validation score.

Thereafter, the method terminates at step [216].

As is evident from the above disclosure, the present invention provides a novel solution for generation of a user feedback data by efficiently and effectively retrieving useful information from the social media platforms. Furthermore, the present invention also provides a solution to filter promotional content, decipher sentiment and extract Business Units (BUs) & Customer Experience Nodes (L1/L2) from various multi-lingual social media posts related to an e-commerce platform/service for user feedback data generation. Also, the present invention provides a solution to estimate based on a user feedback data, an e-commerce company's/business unit's most important metrics like customer experience, Market Share and the like.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

We claim:

1. A method for generation of a user feedback data, the method comprising:
extracting in real time, by an extraction unit [102], from one or more social media platforms, a set of social media posts, wherein each social media post comprises at least one mention related to one or more e-commerce platforms;
categorizing, by a categorization unit [104], each social media post of the set of social media posts into one of a promotional post and non-promotional post based on a first pre-trained dataset;
identifying, by a processing unit [106], a sentiment associated with each social media post based on a second pre-trained dataset;
assigning, by the processing unit [106], at least one of a customer experience node and a business unit with one or more text in each social media post based on a third pre-trained dataset;
removing, by the processing unit [106], at least one irrelevant post from the set of social media posts based at least on at least one of an absence of the customer experience node and a presence of the promotional post; and
generating, by the processing unit [106], the user feedback data from the set of social media posts, based on the removal of the at least one irrelevant post and at least one of the assigned customer experience node of each social media post, the assigned business unit of each social media post, and the sentiment of each social media post.

2. The method as claimed in claim 1, wherein the sentiment is one of a positive sentiment, a negative sentiment and a neutral sentiment.

3. The method as claimed in claim 1, the method further comprises identifying by the processing unit [106], a priority associated with at least one of the customer experience node and the business unit, wherein the customer experience node further comprises one of a L1 and a L2 customer experience node.

4. The method as claimed in claim 3, the method further comprises resolving by the processing unit [106], one or more conflicts associated with one of the L1 and the L2 customer experience node based on the identified priority associated with at least one of the customer experience node and the business unit.

5. The method as claimed in claim 1, wherein the user feedback data comprises at least a set of mentions associated with the one or more e-commerce platforms.

6. The method as claimed in claim 1, the method further comprises generating at least one of a social share metric and a social sentiment score of the one or more e-commerce platforms based on the user feedback data.

7. The method as claimed in claim 6, wherein the social share metric for a first e-commerce platform is generated based on a ratio of said first e-commerce platform's mentions present in the user feedback data to overall mentions present in the user feedback data.

8. The method as claimed in claim 6, wherein the social sentiment score for the first e-commerce platform is generated based on a difference between a user feedback data associated with the first e-commerce platform and a user feedback data associated with a second e-commerce platform.

9. The method as claimed in claim 6, the method further comprises generating at least one of the social share metric and the social sentiment score based on aggregating the user feedback data on at least one of a customer experience node level, geographical level, and business unit level.

10. The method as claimed in claim 1, the method further comprises determining one of a net promoter score and a gross merchandise value based on the user feedback data.

11. The method as claimed in claim 1, wherein:
the first pre-trained dataset comprises a plurality of data trained based at least on a promotional data associated with the one or more e-commerce platforms and a non-promotional data associated with the one or more e-commerce platforms,
the second pre-trained dataset comprises a plurality of data trained based at least on a sentimental data associated with the one or more e-commerce platforms, and
the third pre-trained dataset comprises a plurality of data trained based at least on a customer experience node-based data and a business unit based data.

12. A system for generation of a user feedback data, the system comprising:
an extraction unit [102], configured to extract in real time from one or more social media platforms, a set of social media posts, wherein each social media post comprises at least one mention related to one or more e-commerce platforms;
a categorization unit [104], configured to categorize each social media post of the set of social media posts into one of a promotional post and non-promotional post based on a first pre-trained dataset; and
a processing unit [106], configured to:
identify a sentiment associated with each social media post based on a second pre-trained dataset,
assign, at least one of a customer experience node and a business unit with one or more text in each social media post based on a third pre-trained dataset,
remove, at least one irrelevant post from the set of social media posts based at least on at least one of an absence of the customer experience node and a presence of the promotional post, and
generate, the user feedback data from the set of social media posts, based on the removal of the at least one irrelevant post and at least one of the assigned customer experience node of each social media post, the assigned business unit of each social media post, and the sentiment of each social media post.

13. The system as claimed in claim 12, wherein the sentiment is one of a positive sentiment, a negative sentiment and a neutral sentiment.

14. The system as claimed in claim 12, wherein the processing unit [106] is further configured to identify, a priority associated with at least one of the customer experience node and the business unit, wherein the customer experience node further comprises one of a L1 and a L2 customer experience node.

15. The system as claimed in claim 14, wherein the processing unit [106] is further configured to resolve, one or more conflicts associated with one of the L1 and the L2 customer experience node based on the identified priority associated with at least one of the customer experience node and the business unit.

16. The system as claimed in claim 12, wherein the user feedback data comprises at least a set of mentions associated with the one or more e-commerce platforms.

17. The system as claimed in claim 12, wherein the processing unit [106] is further configured to generate at least one of a social share metric and a social sentiment score of the one or more e-commerce platforms based on the user feedback data.

18. The system as claimed in claim 17, wherein the social share metric for a first e-commerce platform is generated based on a ratio of said first e-commerce platform's mentions present in the user feedback data to overall mentions present in the user feedback data.

19. The system as claimed in claim 17, wherein the social sentiment score for the first e-commerce platform is generated based on a difference between a user feedback data associated with the first e-commerce platform and a user feedback data associated with a second e-commerce platform.

20. The system as claimed in claim 17, wherein the processing unit [106] is further configured to generate at least one of the social share metric and the social sentiment score based on aggregating the user feedback data on at least one of a customer experience node level, geographical level, and business unit level.

21. The system as claimed in claim 12, wherein the processing unit [106] is further configured to determine one of a net promoter score and a gross merchandise value based on the user feedback data.

22. The system as claimed in claim 12, wherein:
the first pre-trained dataset comprises a plurality of data trained based at least on a promotional data associated with the one or more e-commerce platforms and a non-promotional data associated with the one or more e-commerce platforms,
the second pre-trained dataset comprises a plurality of data trained based at least on a sentimental data associated with the one or more e-commerce platforms, and
the third pre-trained dataset comprises a plurality of data trained based at least on a customer experience node-based data and a business unit based data.
